(19) United States
(12) Patent Application Publication
(10) Pub. No.: US 2017/0154648 A1
(43) Pub. Date: Jun. 1, 2017

(54) OPTICAL DISK LIBRARY DEVICE AND SCISSOR-TYPE CONVEYING DEVICE

(71) Applicant: Hitachi-LG Data Storage, Inc., Tokyo (JP)

(72) Inventors: Yoshihiro SATOU, Tokyo (JP); Hiroshi YAMAGISHI, Tokyo (JP); Nozomu HARADA, Tokyo (JP); Hiroki YABU, Tokyo (JP)

(21) Appl. No.: 15/353,040

(22) Filed: Nov. 16, 2016

(30) Foreign Application Priority Data
Nov. 26, 2015 (JP) 2015-230395

(51) Int. Cl. G11B 17/22; G11B 17/02

(52) U.S. Cl. CPC G11B 17/225; G11B 17/02

(57) ABSTRACT

The scissor-type conveying device moves vertically in an optical disk library device and includes a scissor-type conveying device including a slave table including a first driving mechanism used for horizontal movement of an optical-disk handling section that handles optical disks, a base table including a second driving mechanism for lifting and lowering movement, a link mechanism including a plurality of scissors links that couple the slave table and the base table and pins that combine crossing points of the scissors links crossing in an X shape, an opening and closing action of the scissors links being realized by the second driving mechanism, and a movable fixing mechanism that fixes the slave table and the base table to inner wall surfaces defining moving spaces of the slave table and the base table or releases the slave table and the base table from a fixed state to the inner wall surfaces.

### CLAIM OF PRIORITY

The present application claims priority from Japanese patent application JP 2015-230395 filed on Nov. 26, 2015, the content of which is hereby incorporated by reference into this application.

### BACKGROUND OF THE INVENTION

1. Field of the Invention

The present invention relates to an optical disk library device and a self-propelled scissor-type conveying device that ascends and descends in the optical disk library device.

2. Description of the Related Art

The optical disk library device is a device that records, in optical disks, enormous data processed in a data center and enormous data of videos, documents, and the like archived in a library, a broadcasting station, or the like or reproduces the data from the optical disk. In these days, BDs (blue-ray disks) are used as the optical disks.

The optical disk library device includes a housing section that houses the optical disks, a plurality of optical disk drives that record data in and reproduce data from the optical disks, a handling section that conveys the optical disks between the optical disk drives and the optical-disk housing sections, a data processing section including a central processing unit (hereinafter referred to as “CPU”) that processes information in the optical disks, and an interface section that communicates with an external device such as a central instruction device. In the data processing section, the optical disk drives and the CPU are integrated as one module taking maintainability into account.

The optical disk library device is often used as a data backup device. Therefore, main operation of the optical disk library device is recording and storage of data. In the optical disk library device, a data storage capacity is regarded more important than recording and reproducing speed. Therefore, in most cases, a plurality of optical disk drives are mounted on a housing rack.

As an example of the optical disk library device of this type, there is a device described in JP-A-201-203492 (Patent Literature 1). In Patent Literature 1, a recording medium changer, slots and drive blocks of which can be extended, is described. In the recording medium changer, a conveying block capable of moving in the up-down direction (a z direction) is provided. For the movement in the up-down direction of the conveying block, a gear mechanism configured by rack gears and pinion gears is used. For movement in the horizontal direction, a linear guide mechanism is used.

In general, in the gear mechanism, unless the rack gears and the pinion gears are appropriately meshed, biting, tooth skipping, uneven wear, and the like easily occur. Therefore, the rack gears (the housing side) need to be strictly positioned with respect to the pinion gears (the conveying block side) with which the rack gears are meshed. A conveying block chassis corresponding to a main body of the conveying block needs to be kept horizontal. Therefore, driving timings need to be adjusted between the pair of left and right pinion gears However, there is fluctuation due to individual differences in an adjustment amount of the driving timings. Therefore, during assembly of the recording medium changer, the pinion gears needs to be individually adjusted, which makes work complicated.

### SUMMARY OF THE INVENTION

Therefore, the inventor provides an optical disk library device in which various kinds of adjustment are easy compared with the device of the related art.

In order to solve the problems, the present invention adopts, for example, the configuration described in claims. This specification includes a plurality of means for solving the problems. An example of the means is an optical disk library device including: (1) a first housing module including a first space in which a scissor-type conveying device in a folded state is housed; (2) a second housing module including a first housing section that detachably houses one or a plurality of optical disks and/or a second housing section that houses one or a plurality of disk drives that record data in or reproduce data from the optical disks and a second space for the scissor-type conveying device to move in an up-down direction; and (3) a housing rack that houses a singularity of the first housing module and the second housing module in any number of stages. (4) The scissor-type conveying device includes: (4-1) a slave table including a first driving mechanism used for horizontal movement of an optical-disk handling section that handles the optical disks; (4-2) a base table including a second driving mechanism for lifting and lowering movement; (4-3) a link mechanism including a plurality of scissors links that couple the slave table and the base table and pins that combine crossing points of the scissors links crossing in an X shape, an opening and closing action of the scissors links being realized by the second driving mechanism; and (4-4) a movable fixing mechanism that fixes the slave table and the base table to inner wall surfaces defining the first and second spaces or releases the slave table and the base table from a fixed state to the inner wall surfaces.

According to the present invention, it is possible to realize the optical disk library device in which various kinds of adjustment are easy compared with the device of the related art. Problems, configurations, and effects other than those explained above will be made clear by the following explanation of embodiments.

### DESCRIPTION OF THE DRAWINGS

FIG. 1 is a transparent top view of a system configured by an optical disk library device and a central instruction device;

FIG. 2 is a perspective view for explaining the configuration of a second housing module;

FIG. 3 is a perspective view for explaining the configuration of a first housing module;

FIG. 4 is a diagram showing a detailed structure of an optical-disk conveying mechanism;

FIG. 5 is a diagram for explaining an exploded structure of the optical disk library device;

FIG. 6 is a perspective view for explaining a sectional structure of the optical disk library device;

FIG. 7A is a diagram showing an initial position of the optical-disk conveying mechanism;

FIG. 7B is a diagram showing a state in which fixing members on a slave table side are retracted for lifting movement;

FIG. 7C is a diagram showing an extending action of link mechanisms;

FIG. 7D is a diagram showing an action for fitting the fixing members on the slave table side in inner walls of the second housing module in art upper part;

FIG. 7E is a diagram showing a state in which fixing members on a base table side are retracted;

FIG. 7F is a diagram showing an action until the fixing members on the base table side are fit in the inner walls of the second housing module in the upper part after contraction of the link mechanisms;

FIG. 8 is a diagram showing an action for translating an optical-disk handling section to a target position of an optical-disk housing section; and

FIG. 9 is a diagram. showing an action in conveying the optical-disk conveying mechanism, which houses optical disks, to an optical disk drive of the second housing module

### DETAILED DESCRIPTION OF THE INVENTION

Embodiments of the present invention are explained below with reference to the drawings Note that implementation forms of the present invention are not limited to form examples explained below and can be variously modified within the technical idea of the present invention.

(1) First Embodiment

(1-1) Overall Configuration

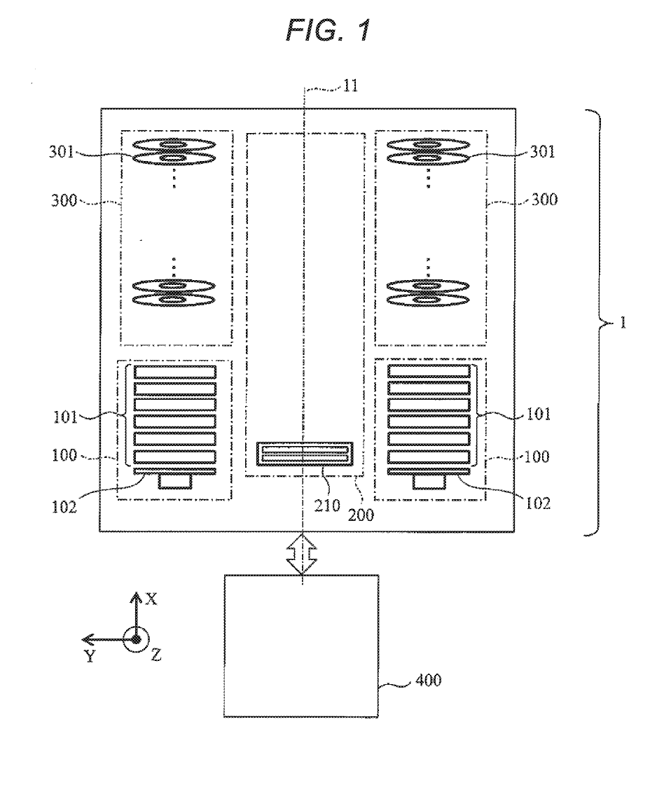

In FIG. 1, a transparent top plane configuration of a library system configured by an optical disk library device 1 and a central instruction device 400 is shown. As explained below in detail, the optical disk library device 1 is configured by (1) a first housing module that gives an initial position (a first space) of an optical-disk conveying mechanism 200 and (2) second housing modules that house recording and reproducing modules 100 and optical-disk. housing sections 300. Pluralities of optical disks 301 are detachably housed in the optical-disk housing sections 300. The first housing module is disposed in the bottom stage and the second housing modules are stacked above the first housing module. In FIG. 1, a plane layout in the second housing module located in the top stage and the optical-disk conveying mechanism 200 are shown. In this specification, the optical-disk conveying mechanism 200 is referred to as scissor-type conveying device as well.

In FIG. 1, spaces for housing the optical-disk housing sections 300 and the recording and reproducing modules 100 (integrated configurations of data processing sections 102 and optical disk drives 101) (hereinafter referred to as “housing spaces”) are symmetrically disposed across a center line 11. The disposition of the housing spaces is common to all the second housing modules. Between the symmetrically disposed housing spaces, a moving space (a space piercing through the upper and lower surfaces of the housing modules) for the optical-disk conveying mechanism 200 to move in the up-down direction is provided. In this specification, the moving space is referred to as second space as well. The optical-disk conveying mechanism 200 freely moves between the first housing module and the second housing modules through the moving space (the second space). Note that a disposition position of the moving space (the second space) coincides with the initial position (the first space) as well.

The central instruction device 400 controls writing of data in or readout of data from the optical disks 301 through communication with the recording and reproducing modules 100 (specifically, the data processing sections 102), the optical-disk conveying mechanism 200, and an optical-disk handling section 210. The central instruction device 400 includes a computer as a basic configuration. A control operation of the central instruction device 400 is controlled by a CPU that executes a computer program stored in a storage device incorporated in the central instruction device 400. In FIG. 1, the central instruction device 400 is shown as an external device of the optical disk library device 1. However, the central instruction device 400 maybe integrated with the optical disk library device 1.

(1-2) Configuration of a Second Housing Module 20

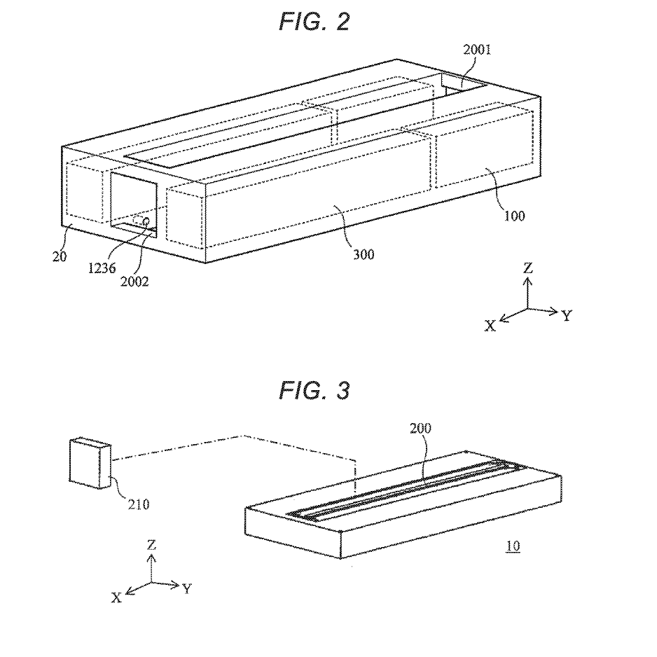

The configuration of a second housing module 20 is shown in FIG. 2. The housing module 20 is a module that is additionally installed or removed according to necessity. The spaces for housing the optical-disk housing sections 300 and the recording and reproducing modules 100 are provided on both the left and right sides across a moving space 2001 (the second space) piercing through the upper and lower surfaces of the second housing module 20. As explained above, the moving space 2001 is a space for the optical-disk conveying mechanism 200 to move up and down and is provided in the center of the module.

On inner wall surfaces of the module defining the moving space 2001, fitting sections 1236 for positioning and fixing the optical-disk conveying mechanism 200 are disposed. Four fitting sections 1236 in total are provided, two each on the lower sides of a pair of left and right inner walls. The fitting sections 1236 have a concave shape (e.g., a cylindrical shape) and are configured to fit with fixing members having a convex shape (e.g., a columnar shape) let out from the optical-disk conveying mechanism 200. Opening sections 2002 communicating with the moving space 2001 are formed on side surfaces of the short sides of the second housing module 20. The opening sections 2002 are work spaces for attaching and detaching upper and lower rails (not shown in the figure), which guide movement in the up-down direction of the optical-disk conveying mechanism 200, to and from the inner wall surfaces of the module.

The second housing module 20 basically includes housing spaces (first housing sections) for the optical-disk housing sections 300 that house the optical disks 301 and housing spaces (second housing sections) for the recording and reproducing modules 100. However, a form of use of the housing spaces provided in the second housing module 20 is not limited to the form. For example, when it is desired to increase a storage capacity, it is also possible to remove the housing spaces (the second housing sections) for the recording and reproducing modules 100 and allocate the housing spaces (the first housing sections) for the optical-disk housing sections 300 to all the spaces. On the other hand, when it is desired to increase recording and reproducing speed, it is also possible to reduce a ratio of the housing spaces (the first housing sections) for the optical-disk housing sections 300 or remove the housing spaces and allocate the spaces to the housing spaces (the second housing sections) for the recording and reproducing modules 100. That is, it is possible to change the form of use of the housing spaces according to a purpose of use.

(1-3) Configuration of a First Housing Module 10

The configuration of a first housing module 10 is shown in FIG. 3. A space (a first space) for housing the optical-disk conveying mechanism 200 is provided in The center of The first housing module 10. Eight fitting sections (not shown in the figure) in total are provided on inner wall surfaces of the module defining the first space, two each on the upper sides and The lower sides of the inner wall surfaces. The fitting sections have a shape same as the shape of the fitting sections 1236. Therefore, the fitting sections provided in the first housing module 10 are also used to fix the optical-disk conveying mechanism 200.

The first space provided. in the first housing module 10 is disposed such that the first space and the moving space 2001 on the second housing module 20 side form one space when the second housing module 20 is stacked on the upper surface of the first housing module 10. With this configuration, the optical-disk conveying mechanism 200 can freely move between the first housing module 10 and the second housing module 20. With this configuration, it is unnecessary to dispose the optical-disk handling section 210 for each of the second housing modules 20.

The optical disk handling section 210 is mounted on the upper surface of the optical-disk conveying mechanism 200 o The optical-disk handling section 210 is used for exchange of the optical disks 301 between the optical-disk housing sections 300 and the optical disk. drives 101 of the recording and reproducing modules 100 and storage of the optical disks 301 during conveyance . The dimension of the optical-disk handling section 210 is set smaller than the width of the optical-disk conveying mechanism 200 (i.e., set smaller than the width of the moving space 2001). The optical-disk handling section 210 is attached to the optical-disk conveying mechanism 200 to project from the upper surface of the second housing module 20. When portability is taken into account, the optical-disk handling section 210 is desirably removable from the optical-disk conveying mechanism 200.

The size of the first housing module 10 is a size that can be fit in a housing rack (an external housing of the optical disk library device 1) explained below. The width and the depth of the first housing module 10 are the same as the width and the depth of the second housing module 20. However, the height of the first housing module 10 is set to approximately a half of the height of the second housing module 20 not to affect the number of mounted second housing modules 20. The inside of the second housing module 20 is a void except the space (the first space) for housing the optical-disk conveying mechanism 200. Therefore, in general, the second housing module 20 is utilized as a place for disposing a power supply and a cable.

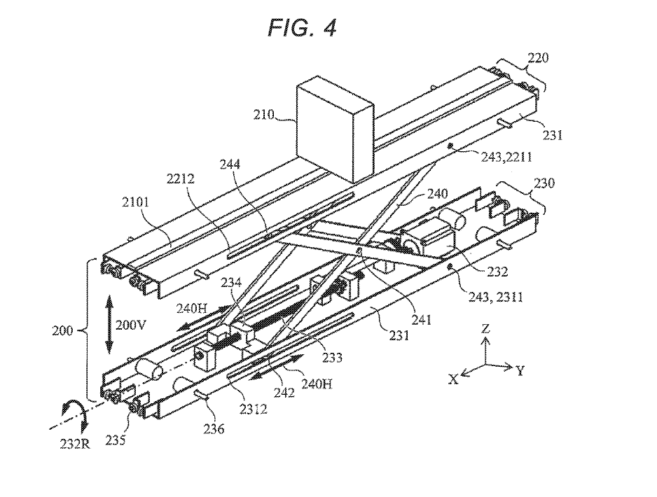

The structure of the optical-disk conveying mechanism 200 is explained with reference to FIG. 4. As explained above, the mechanism is a mechanism for conveying the optical disks 301 between the optical-disk housing sections 300 and the optical-disk drives 101.

A detailed configuration of the optical-disk conveying mechanism 200 is shown in FIG. 4. The optical-disk conveying mechanism 200 is configured by (1) a slave table 220 mounted with a linear motion mechanism 2101 that moves the optical-disk handling section 210 along the longitudinal direction thereof (the horizontal direction), (2) a base table 230 functioning as a base for the slave table 220 and mounted with a lifting and lowering driving mechanism (configured from a driving motor 232, a lead screw 233, and the like), and (3) link mechanisms (configured from scissors links 240 crossing in an X shape and supported by pins 241 in crossing points thereof) that couple the two tables each other. As shown in FIG. 4, the slave table 220 and the base table 230 have a C shape in section. Two link mechanisms are disposd in total, one each on the left and the right of the tables. Note that three or more link mechanisms may be disposed.

Each of the slave table 220 and the base table 230 includes two table side surfaces 231 extending perpendicularly to the bottom surface (the upper surface). Each of the tables (the table side surfaces 231) and the link mechanism are coupled at two coupling points. One of the two coupling points is supported by a pin 243 on the table side surface 231. That is, each of the slave table 220 and the base table 230 is attached using a hole 2211 or 2311 formed on the table side surface 231 and the pin 243. Consequently, one end of the scissors link 240 is rotatably fixed to the table. Note that the structure of the tables is not limited to this structure as long as the pin supporting is possible.

The other of the two coupling points is slidably supported on each of the table. A guide hole 2212 or 231 formed on the table side surface 231 to correspond to the coupling point. The guide hole 2212 or 2312 extends in the longitudinal direction of the table. A pin 242 or 244 projecting from the end portion of the scissors link 240 is supported while being inserted into the guide hole 2212 or 2312. Therefore, the pin 242 or 244 can move in parallel along the inner side of the guide hole 2212 or 2312. In FIG. 4, a moving direction of the pin 242 or 244 is indicated by 240H.

On the table side surface 231, a movable fixing mechanism for fitting in the fitting sections provided on the module inner walls and fixing the tables is provided. The fixing mechanism is configured by a fixing member 236 functioning as a movable member and a driving section (e.g., a motor) that inserts the fixing member 236 into and pulls out the fixing member 236 from the table side surface 231. Four fixing mechanisms are provided in each of the tables. Rollers 235 for grasping upper and lower rails (not shown in the figure) provided. on the housing inner wall surfaces for the purpose of improving stability of the tables in moving the optical-disk conveying mechanism 200 in the up-down direction are attached to each of the slave table 220 and the base table 230. In FIG. 4, four rollers 235 are disposed in each of the tables.

The linear motion mechanism 2101 such as a linear guide is mounted on the slave table 220 as a moving mechanism for the optical-disk handling section 210. The linear motion mechanism 2101 is a mechanism that converts rotation of a rotating shaft driven to rotate by a motor into a linear motion of a linear motion member. In FIG. 4, a moving direction of the optical-disk handling section 210 is an X direction (a linear direction).

The optical-disk conveying mechanism 200 moves between the housing modules according to an opening and closing action of the link mechanisms. A lifting and lowering action (an action for changing height) of the scissor-type link mechanisms is realized by a change in intervals between the coupling points of the scissors links 240 in the tables (i.e., an interval between the pin 243 and the pin 242 and an interval between the pin 243 and the pin 244). The pins 242 and 243 on the slide-supported side are attached to a coupling member 234. In the coupling member 234, a female screw is formed in an intermediate position thereof e The female screw is coupled to the lead screw 233, which is a male screw.

The driving motor 232 drives to rotate the lead screw 233. The coupling member 234 moves by length corresponding f to a rotation amount o the lead screw 233. That is, a rotation force (in a 232R direction) generated by the driving motor 232 is converted into a translation force by the lead screw 233 and the female screw. As a result, the coupling member 234 moves in parallel (in a 240H direction). Consequently, the intervals between the pin supporting points and the slide supporting points of the tables change. A relative position (in a 200V direction) between the tables changes according to a link motion. A lifting and lowering driving mechanism (the driving motor 232, the lead screw 233, and the coupling member 234) disposed in the base table 230 is also a linear motion mechanism.

When the relative distance between the tables is increased, when the base table 230 side is fixed, the slave table 220 ascends When the slave table 220 side is fixed, the base table 230 descends During actual movement, positions fixed to the module inner walls are determined according to a moving direction. In this way, the optical-disk conveying mechanism 200 in this embodiment autonomously moves in the up-down direction by repeating operation for moving, in a state in which one of the slave table 220 and the base table 230 is fixed, the other in the up-down direction.

Note that the operation of the driving motor 232, the operation of the driving motor for inserting and pulling out the fixing members 236, the operation of the linear motion mechanism 2101, and the operation of the optical-disk handling section 210 are controlled through communication with the central instruction device 400. For the communication, various cables may be used or wireless communication may be used. Therefore, a not-shown communication interface is mounted on the optical-disk conveying mechanism 200.

In the optical-disk conveying mechanism 200 in this embodiment, scissor-type link mechanisms are used for the movement in the up-down direction. Therefore, it is possible to easily keep the slave table 220 horizontal, In this embodiment, in changing the relative distance between the slave table 220 and the base table 230, the linear motion mechanism 2101 controlled such that the position of the optical-disk handling section 210 is always located on vertical lines passing geometrical centers (i.e., the crossing points 241) of the link mechanisms.

In this embodiment, before the movement in the up-down direction is started, the linear motion mechanism 2101 positions the position of the optical-disk handling section 210 on the vertical lines of the geometrical centers of the link mechanisms After the movement in the up-down direction is started, the position of the optical-disk handling section 210 is moved by the movement of the geometrical centers such that the position of the optical-disk handling section 210 does not deviate from the vertical lines of the geometrical centers of the link mechanisms. According to this control, the optical-disk conveying mechanism 200 is unlikely to lose a supporting balance even during the movement in the up-down direction.

The control for positioning the position of the optical-disk handling section 210 on the vertical lines passing the geometrical centers (i.e., the crossing points 241) of the scissor-type link mechanisms may be executed only once during the start of the movement in the up-down direction. In this case, when the movement in the up-down direction is started, the supporting balance cannot be maintained in a strict sense. However, a shift amount in the horizontal direction between the position of the optical-disk handling section 210 and the geometrical centers (i.e., the crossing points 241) of the link mechanisms can be kept within a small range. The loss of the supporting balance can be minimized.

(1-4) Assembly of the Optical Disk Library Device 1

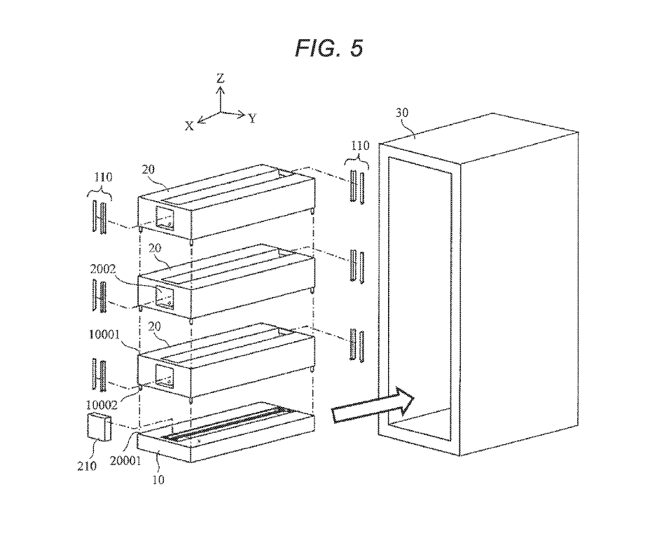

An assembly example of the optical disk library device 1 is shown in FIG. 5. FIG. 5 shows an example in which one first housing module 10 and three second housing modules 20 are mounted on a housing rack 30. Mounting order of the modules is explained below.

(a) First, the first housing module 10 is set in the bottom stage of the housing rack 30. In the first housing module 10, the optical-disk conveying mechanism 200 in a folded state is housed.

(b) The optical-disk handling section 210 is fit in the upper surface of the optical-disk conveying mechanism 200.

(c) Subsequently, the first second housing module 20 is laid above the first housing module 10. At this point, the second housing module 20 and the first housing module 10 are positioned by positioning members 10002 and 20001 equipped therein.

(d) Subsequently, upper and lower rails 110 are attached to the module inner walls through the opening section 2002 provided on a side surface of the second housing module 20. The upper and lower rails 110 after the attachment are grasped by the rollers 235 when the optical-disc conveying mechanism 200 moves up and down. The length of the upper and lower rails 110 is length matching the height of the second housing module 20. The upper and lower rails 110 are attached to, from the inner side, the side surface on which the opening section 2002 is provided. In this way, the upper and lower rails 110 in this embodiment are disposed to be detachable in each of the second housing modules 20. Therefore, it is possible to improve workability when the number of second housing modules 20 is changed or when maintenance of internal devices is performed. At the same time, it is possible to realize a reduction in cost.

(e) Thereafter, the second housing modules 20 and the upper and lower rails 110 are alternately set. The upper and lower rails 110 are attached to fit with the upper and lower rails 110 (on the lower stage side) set earlier and are assembled to be one long rail. Positioning of the second housing modules 20 is performed by positioning members 10001 and 10002 equipped in the modules as explained above. According to the series of work, setting of the second housing modules 20 in a desired number of stages in the housing rack 30 is completed.

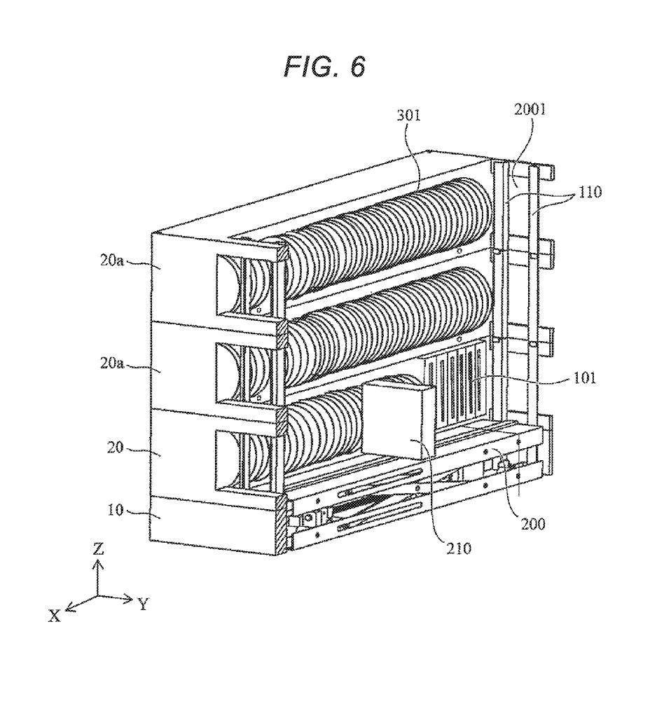

In FIG. 6, an internal configuration after the mounting of the modules ends in the housing rack 30 is shown. FIG. 6 shows the vicinity of the center of the housing rack 30 in a fractured state. As shown in FIG. 6, the moving space 2001 for the optical-disk conveying mechanism 200 to move in the up-down direction is provided above the optical-disk conveying mechanism 200. FIG. 6, the data processing section 102, the optical disk drive 101, and the optical-disk housing section 300 are mounted in the second housing module 20 in the first stage. However, only the optical-disk housing sections 300 are mounted in second housing modules 20a in the second and third stages.

(1-5) Operation of the Optical-Disk Conveying Mechanism

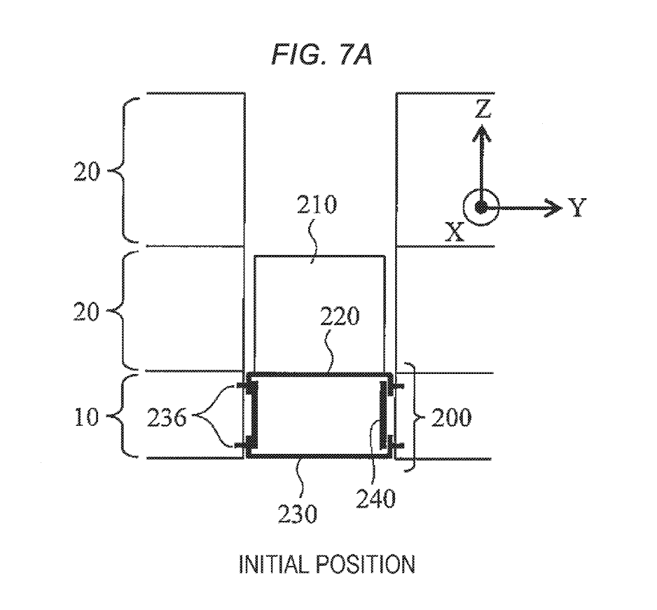

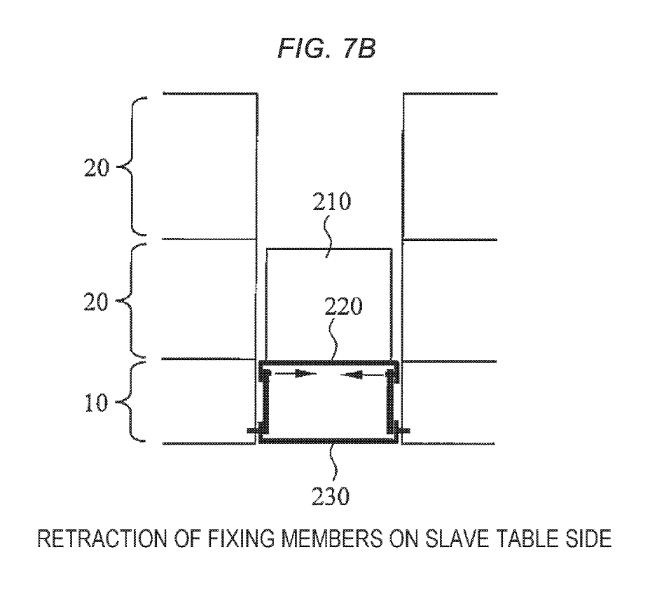

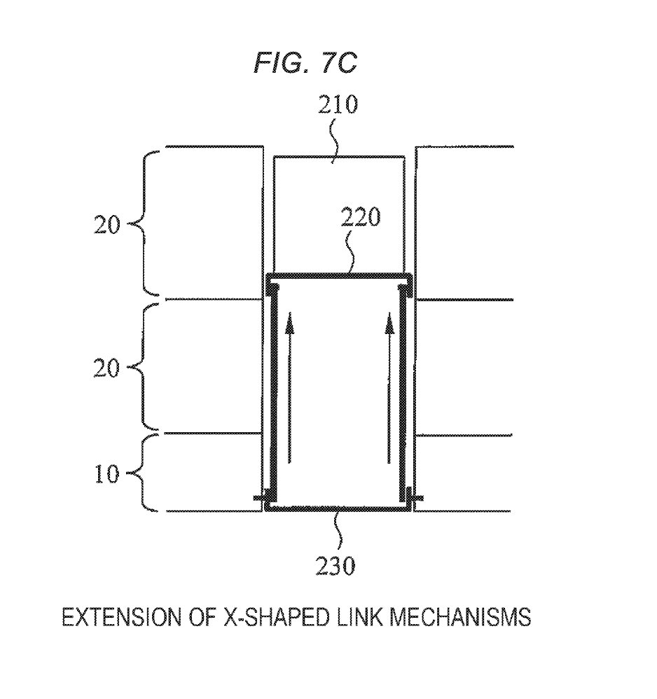

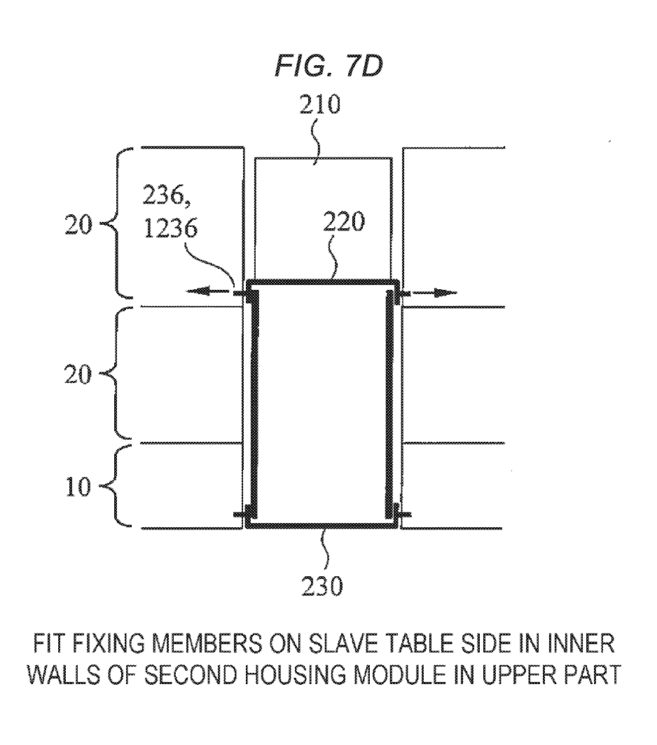

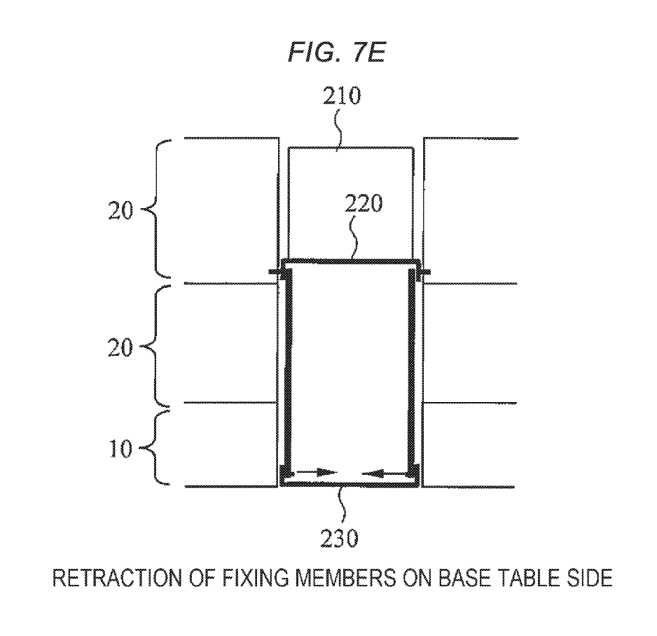

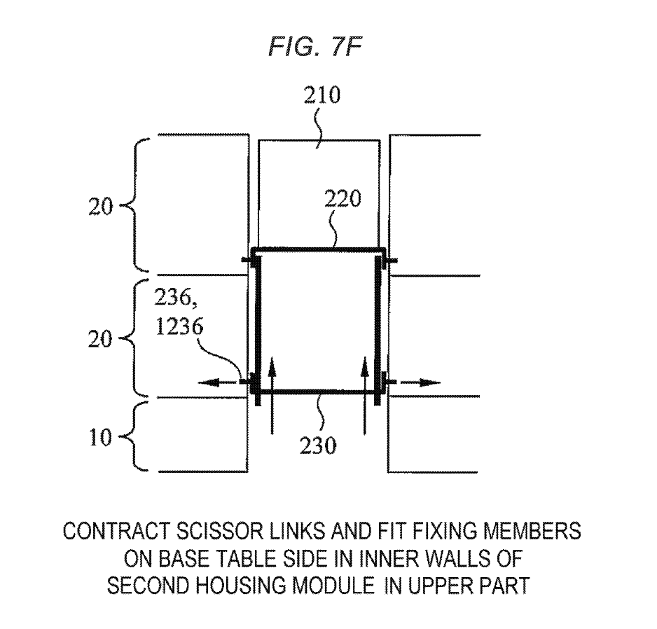

The operation of the optical-disk conveying mechanism 200 is explained with reference to FIGS. 7A to 7F, 8, and 9. The first housing module 10 is set in the bottom stage of the housing rack 30. Two second housing modules 20 are stacked on the first housing module 10.

The operation explained below is started when a data recording and reproducing instruction is generated from the central instruction device 400 to the data processing section 102 of the optical disk library device 1. When content of the instruction is a recording command, the data processing section 102 instructs the optical-disk conveying mechanism 200 to take out the optical disk 301 having a recording region from the optical-disk housing section 300. On the other hand, when the content of the instruction is a reproduction command, the data processing section 102 instructs the optical-disk conveying mechanism 200 to take out a recorded optical disk 301. In general, a place where the optical disk 301 is taken out is random. Therefore, in most cases, the optical-disk conveying mechanism 200 moves across the second housing modules 20 in upper and lower two stages.

In FIG. 7A, a state of an initial position (during standby) is shown. In the initial position, the optical-disk conveying mechanism 200 is housed on the inside of the first housing module 10. That is, the optical-disk conveying mechanism 200 is absent in all the second housing modules 20. In this case, the optical-disk conveying mechanism 200 is fixed with the fixing members 236 fit in the eight fitting sections in total provided on the inner walls of the first housing module 10.

As shown in FIG. 7B, the data processing section 102, which receives a moving instruction, retracts the fixing members 236 of the slave table 220 from the fitting sections and releases the fixed state of the optical-disk conveying mechanism 200. Consequently, the slave table 220 is enabled to move. Note that the fixing members 236 of the base table 230 are kept fixed on the module inner walls.

Subsequently, the data processing section 102 controls the driving motor 232 to drive to rotate the lead screw 233 and translate the coupling member 234 to approach the driving motor 232. Consequently, a driving force is transmitted to the scissors links 240 through the coupling member 234. The driving force acts on the scissors links 240 in a direction in which the scissors links 240 spread upward from a folded state. At this point, the base table 230 is kept fixed to the inner walls of the first housing module 10. Therefore, the slave table 220 is pushed up as shown in FIG. 7C. The interval between the slave table 220 and the base table 230 widens. As a characteristic of the scissor-type link mechanisms, the slave table 220 ascends while maintaining the horizontal state.

When the slave table 220 reaches target height, as shown in FIG. 7D, the fixing members 236 are let out from the side surfaces of the slave table 220 and fit in the fitting sections 1236 provided in the second housing module 20. Consequently, the slave table 220 fixed to the second housing module 20. Subsequently, in order to reduce the extended scissors links 240 to appropriate length, the data processing section 102 shifts to an action for pulling up the base table 230. First, as shown in FIG. 7E, the data processing section 102 retracts the fixing members 236 of the base table 230 from the fitting sections and releases the fixed state between the base table 230 and the inner walls of the first housing module 10.

Subsequently, the data processing section 102 controls the driving motor 232 to drive to rotate the lead screw 233 and translates the coupling member 234 in a direction away from the driving motor 232. Consequently, a driving force is transmitted to the scissors links 240 through the coupling members 234. The driving force acts on the scissors links 240 to be reduced (folded). Since the slave table 220 is kept fixed to the inner walls of the second housing module 20, the base table 230 is pulled up as shown in FIG. 7F. The interval between the slave table 220 and the base table 230 decreases.

When the base table 230 reaches target height, the fixing members 236 are let out from the side surfaces of the base table 230 and fit in the fitting sections 1236 provided in the second housing module 20. Consequently, the base table 230 is fixed to the second housing module 20 For the lift of the optical-disk. conveying mechanism 200, a series of actions shown in FIGS. 7A to 7F are basic actions. When it is necessary to lift the optical-disk conveying mechanism 200 by two or more stages, the actions of FIGS. 7A to 7F are repeated by a necessary number of stages.

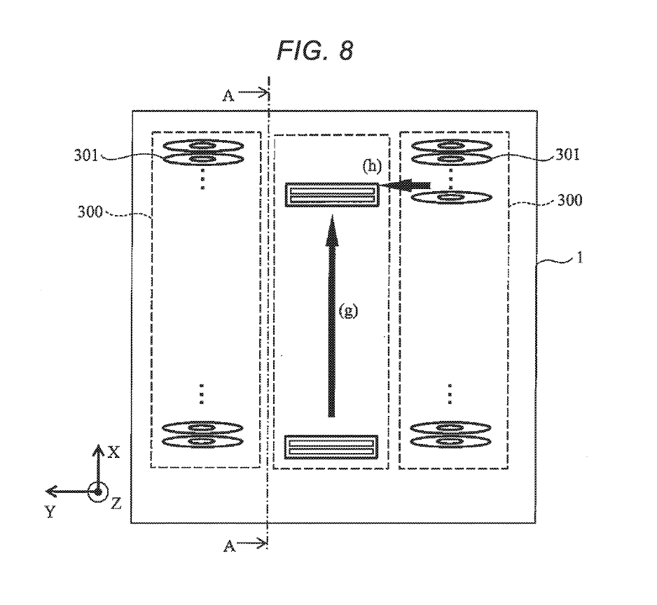

When the optical-disk conveying mechanism 200 reaches height where the optical-disk housing section 300, which houses the target optical disk 301, is present, an action for translating the optical-disk handling section 210 is started. The action is shown in FIG. 8 The optical-disk handling section 210 moves in the X direction along the surface of the slave table 220 (an action (g)) and receives a desired optical disk 301 in a position where the optical disk 301 is housed (an action (h)).

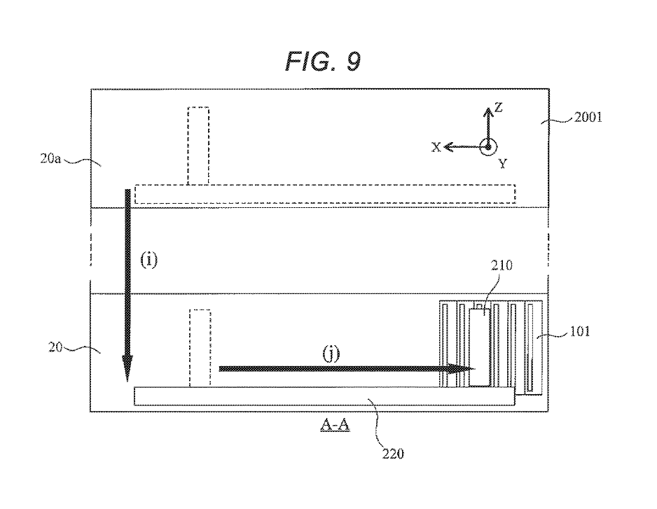

In FIG. 8, the optical disk drive 101 is not mounted in a plane on which the optical-disk handling section 210 is movable Therefore, the received optical disk 301 has to be moved to the second housing module 20 in which the optical disk drive 101 is present. This action is explained with reference to FIG. 9. In FIG. 9, the optical disk drive 101 is located in the bottom stage. Therefore, data processing section 102 instructs the optical-disk conveying mechanism 200 to descend.

In this case, the optical-disk conveying mechanism 200 performs actions opposite to the actions shown in FIGS. 7A to 7F and descends Specifically, first, the optical-disk conveying mechanism 200 performs an action for lowering the base table 230 (an action (i)) and then lowering the slave table 220. Consequently, the optical-disk conveying mechanism 200 reaches target height where the optical disk drive 101 is present. Thereafter, the optical-disk conveying mechanism 200 drives the optical-disk handling section 210 in the horizontal direction (an action (j)) to move the optical-disk handling section 210 to a target place of the optical disk drive 101 Thereafter, the optical-disk handling section 210 passes, with the moving mechanism 2101, the conveyed optical disk 301 to the optical disk drive 101. Consequently, the optical disk drive 101 becomes capable of recording data in and reproducing data from the optical disk 301. The data is transmitted and received between the optical disk 301 and the central instruction device 400.

The lifting and lowering action of the optical-disk. conveying mechanism 200 is supplemented. When stability of actions of the tables configuring the optical-disk conveying mechanism 200 is taken into account, an angle formed by the respective scissors links 240 and the tables when the optical-disk conveying mechanism 200 extends is desirably set to a maximum of approximately 60 degrees. This is because, since the distance between the coupling member 234, which drives the scissors links 240, and the driving motor 232 decreases, a swinging action. to the front and the rear (pitching) easily occurs and acts as resistance against the up-down driving force. Actually, since the angle depends on link length of the scissors links 240, an extension amount of the optical-disk conveying mechanism 200 is determined according to a boundary condition during design. For example, extension height of the optical-disk conveying mechanism 200 is set to height equivalent to two stages of the second housing modules 20.

The operation explained above is based on the premise that the optical disks 301 are absent in the optical disk drive 101. However, the same operation is performed even when the optical disks 301 are present in the optical disk drive 101. For example, even when replacement of the optical disk 301 is necessary, an action for fetching the optical disk 301 from the optical disk drive 101 is only added before the optical-disk conveying mechanism 200 is moved to the optical-disk housing section 300.

(1-6) Maintenance

Necessary work during maintenance such as replacement of the second housing module 20 mounted in the housing rack 30 is explained. When the optical disk library device 1 is broken down, in order to enable replacement of the second housing module 20 by a maintenance operator or the like, the central instruction device 400, which controls the device, retracts the optical-disk conveying mechanism 200 to a position near the module two or more stages away from the replacement target module. A method of moving the optical-disk conveying mechanism 200 during the retraction is the same as the operation in conveying the optical disk 301. Note that the number of stages of the retraction is not limited to two.

When the retraction is completed and the maintenance can be performed, the operator detaches the upper and lower rails 110 (FIGS. 5 and 6) from the pertinent module. A coupled state of the second housing modules 20 is released by the detachment of the upper and lower rails 110. Thereafter, the operator detaches the pertinent second housing module 20 from the housing rack 30. Subsequently, the operator mounts another second housing module 20 in the housing rack 30 and attaches, through the opening section 2002, the upper and lower rails 110 detached earlier. After the replacement work ends, the central instruction device 400 checks presence or absence of deficiencies of the optical disk library device 1. For example, the central instruction device 400 performs a moving test of the optical-disk conveying mechanism 200. When confirming that there is no deficiency, the central instruction device 400 shifts to the normal operation and starts work.

(1-7) Effects

In the optical disk library device 1 in this embodiment, it is possible to increase and reduce, with simple work, the number of stages of the second housing modules 20 including the optical-disk housing sections 300, which houses the plurality of optical disks 301, and/or the recording and reproducing modules 100 in particular, since the optical-disk conveying mechanism 200 is the self-propelled mechanism, during maintenance, work can be performed by retracting the optical-disk conveying mechanism 200 to any position. Since the self-propelled optical-disk conveying mechanism 200 is configured by the scissor-type link mechanism, even if the complicated adjustment work of the device of the related art is not performed, it is possible to keep the slave table 220 horizontal.

(1-8) Other Embodiments

The present invention is not limited to the embodiment explained above and includes various modifications. For example, the embodiment is explained in detail in order to clearly explain the present invention. The present invention does not always need to include all of the explained configurations. A part of the embodiment can be replaced with other configurations. Other configurations can be added to the configurations of the embodiment. A part of the embodiment can be deleted.

A part or all of the components, functions, the processing sections, the processing means, and the like explained above may be realized by hardware by, for example, designing the components, functions, the processing sections, the processing means, and the like as integrated circuits. The components, the functions, and the like may be realized by a processor interpreting and executing (i.e., in terms of software) computer programs for realizing the respective functions. Information such as computer programs, tables, and files for realizing the functions can be stored in storage devices such as a memory, a hard disk, and an SSD (Solid State Drive) or storage media such as an IC card, an SD card, and a DVD. Control lines and information lines considered to be necessary for explanation are shown. Not all of control lines and information lines necessary for a product are shown. Actually, almost all of the components are connected to one another.

What is claimed is:

1. An optical disk library device comprising:
a first housing module including a first space in which a scissor-type conveying device in a folded state is housed;
a second housing module including a first housing section that detachably houses one or a plurality of optical disks and/or a second housing section that houses one or a plurality of disk drives that record data in or reproduce data from the optical disks and a second space for the scissor-type conveying device to move in an up-down direction; and
a housing rack that houses a singularity of the first housing module and the second housing module in any number of stages, wherein
the scissor-type conveying device includes:
a slave table including a first driving mechanism used for horizontal movement of an optical-disk handling section that handles the optical disks;
a base table including a second driving mechanism for lifting and lowering movement;
a link mechanism including a plurality of scissors links that couple the slave table and the base table and pins that combine crossing points of the scissors links crossing in an X shape, an opening and closing action of the scissors links being realized by the second driving mechanism; and
a movable fixing mechanism that fixes the slave table and the base table to inner wall surfaces defining the first and second spaces or releases the slave table and the base table from a fixed state to the inner wall surfaces.

2. The optical disk library device according to claim 1, wherein the scissor-type conveying device executes, during ascending, in order, an action for releasing the slave table from the inner wall surfaces while keeping a state in which the base table is fixed to the inner wall surfaces, an action for extending the link mechanism with the second driving mechanism and lifting the slave table, an action for fixing the slave table to the inner wall surfaces, an action for releasing the base table from the inner wall surfaces, an action for contracting the link mechanism with the second driving mechanism and lifting the base table, and an action for fixing the base table to the inner wall surfaces, and, during descending, executes, in order, an action for releasing the base table from the inner wall surfaces while keeping a state in which the slave table is fixed to the inner wall surfaces, an action for extending the link mechanism with the second driving mechanism and lowering the base table, an action for fixing the base table to the inner wall surfaces, an action for releasing the slave table from the inner wall surfaces, an action for contracting the link mechanism with the second driving mechanism and lowering the slave table, and an action for fixing the slave table to the inner wall surfaces.

3. The optical disk library device according to claim 1, wherein the scissor-type conveying device moves a position of the optical-disk handling section according to movement of the crossing points such that, before a start of a lifting and lowering action, the position of the optical-disk handling section is positioned on vertical lines of the crossing points of the scissors links and, after the lifting and lowering action is started, during the lifting and lowering action, the position of the optical-disk handling section is always located on the vertical lines of the crossing points of the scissors links.

4. The optical disk library device according to claim 1, wherein, in the scissor-type conveying device, before a start of a lifting and lowering action, a position of the optical-disk handling section is positioned on vertical lines of the crossing points of the scissors links.

5. The optical disk library device according to claim 1, wherein, during replacement of the second housing module, the scissor-type conveying device retracts from a position of the second housing module to be replaced to a position of another one of the second housing modules or a position of the first housing module.

6. The optical disk library device according to claim 1, further comprising upper and lower rails that guide ascending and descending of the scissor-type conveying device, the upper and lower rails having length equivalent to height of the second housing modules, wherein
the upper and lower rails are detachable from inner walls of the second housing modules.

7. A scissor-type conveying device comprising:
a slave table including a first driving mechanism used for horizontal movement of an optical-disk handling section that handles optical disks;
a base table including a second driving mechanism for lifting and lowering movement;
a link mechanism including a plurality of scissors links that couple the slave table and the base table and pins that combine crossing points of the scissors links crossing in an X shape, an opening and closing action of the scissors links being realized by the second driving mechanism; and
a movable fixing mechanism that fixes the slave table and the base table to inner wall surfaces defining moving spaces of the slave table and the base table or releases the slave table and the base table from a fixed state to the inner wall surfaces.

8. The scissor-type conveying device according to claim 7, wherein the scissor-type conveying device executes, during ascending, in order, an action for releasing the slave table from the inner wall surfaces while keeping a state in which the base table is fixed to the inner wall surfaces, an action for extending the link mechanism with the second driving mechanism and lifting the slave table, an action for fixing the slave table to the inner wall surfaces, an action for releasing the base table from the inner wall surfaces, an action for contracting the link mechanism with the second driving mechanism and lifting the base table, and an action for fixing the base table to the inner wall surfaces, and, during descending, executes, in order, an action for releasing the base table from the inner wall surfaces while keeping a state in which the slave table is fixed to the inner wall surfaces, an action for extending the link mechanism with the second driving mechanism and lowering the base table, an action for fixing the base table to the inner wall surfaces, an action for releasing the slave table from the inner wall surfaces, an action for contracting the link mechanism with the second driving mechanism and lowering the slave table, and an action for fixing the slave table to the inner wall surface.

9. The scissor-type conveying device according to claim 7, wherein the scissor-type conveying device moves a position of the optical-disk handling section according to movement of the crossing points such that, before a start of a lifting and lowering action, the position of the optical-disk handling section is positioned on vertical lines of the crossing points of the scissors links and, after the lifting and lowering action is started, during the lifting and lowering action, the position of the optical-disk handling section is always located on the vertical lines of the crossing points of the scissors links.

10. The scissor-type conveying device according to claim 7, wherein, before a start of a lifting and lowering action, a position of the optical-disk handling section is positioned on vertical lines of the crossing points of the scissors links.
